(19) United States
(12) Patent Application Publication
(10) Pub. No.: US 2009/0211819 A1
(43) Pub. Date: Aug. 27, 2009

(54) TOUCH PANEL

(76) Inventors: Chih-Yuan Wang, Tai Chung County (TW); Cheng-Yi Chou, Yun Lin County (TW); Jyun-Sian Li, Tai Nan City (TW)

Correspondence Address: Muncy, Geissler, Olds & Lowe, PLLC, P.O. BOX 1364, FAIRFAX, VA, 22038-1364, US

(21) Appl. No.: 12/392,652

(22) Filed: Feb. 25, 2009

Related U.S. Application Data
(60) Provisional application No. 61/031,408, filed on Feb. 26, 2008.

(51) Int. Cl. G06F 3/041

(52) U.S. Cl. 178/18.03

(57) ABSTRACT

A touch panel includes a first and a second transparent substrates, a first and a second signal lines, a first polymeric conductive film, and a first and a second non-polymeric conductive films. The first signal line is formed on the first transparent substrate, the first polymeric conductive film is formed on the first transparent substrate, and the first non-polymeric conductive film is formed on the first polymeric conductive film. The second signal line is provided on the second transparent substrate, and the second non-polymeric conductive film is provided on the second transparent substrate.

### CROSS REFERENCE TO RELATED APPLICATION

This application claims benefit of U.S. provisional application No. 61/031,408 filed on Feb. 26, 2008 under 35 U.S.C. § 119(e); the entire contents of which are hereby incorporated by reference.

### BACKGROUND OF THE INVENTION

1. Field of the Invention

The invention relates to a touch panel, particularly to a touch panel having transparent conductive films with excellent physical characteristics.

2. Description of the Related Art

FIG. 1 shows a schematic diagram of a conventional touch panel 100. Referring to FIG. 1, the touch panel 100 includes a top electrode substrate 102 and a bottom electrode substrate 104 facing to each other. The top electrode substrate 102 includes a transparent substrate 110, an ITO conductive film 112 formed on the transparent substrate 110, and signal transmission lines 114. The bottom electrode substrate 104 includes a transparent substrate 120, an ITO conductive film 122 formed on the transparent substrate 120, and signal transmission lines 124. The top electrode substrate 102 and the bottom electrode substrate 104 are connected with each other by an adhesive AH.

In the conventional design shown in FIG. 1, the ITO conductive films 112 and 122 are deposited on the transparent substrates 110 and 120, respectively, through vacuum coating, and thus they are stably fabricated and have high electrical conductivity. However, under a critical condition where surface resistivity reaches 500 ohm, its bearable number of times for drawing a line on a touch screen is not allowed to exceed 50,000 to result in a comparatively limited operation life. Further, the ITO conductive films 112 and 122 each have a high refraction index and are liable to reflect incoming light to result in a light yellow screen color. The light yellow screen color may cause a shift in the color tone of a displayed image. Besides, the ITO conductive films 112 and 122 are prone to crack upon bending due to their inferior flexibility to sharply raise electrical resistances.

FIG. 2 shows a schematic diagram of another conventional touch panel 200. Referring to FIG. 2, the touch panel 200 includes a top electrode substrate 202 and a bottom electrode substrate 204 facing to each other. The top electrode substrate 202 includes a transparent substrate 210, a polymeric conductive film 212 formed on the transparent substrate 210, and signal transmission lines 214. The bottom electrode substrate 204 includes a transparent substrate 220, an ITO conductive film 222 formed on the transparent substrate 220, and signal transmission lines 224. The top electrode substrate 202 and the bottom electrode substrate 204 are connected with each other by an adhesive AH.

In the conventional design shown in FIG. 2, the polymeric conductive film 212 formed on the transparent substrate 210 has competent flexibility to avoid crack and is not naturally light yellow thus not to influence the color tone of a displayed image. Besides, the polymeric conductive film 212 is deposited on the transparent substrate 210 at normal pressure to allow for comparatively low fabrication costs. However, the polymeric conductive film 212 has inferior electrical conductivity and high surface resistivity, which often cause inferior reliability and a drift to the linear response when one draws a line on the touch screen.

### BRIEF SUMMARY OF THE INVENTION

The invention relates to a touch panel capable of overcoming the disadvantages of conventional designs.

According to an embodiment of the invention, a touch panel includes a first and a second transparent substrates, a first and a second signal lines, a first polymeric conductive film, a first non-polymeric conductive film, a second non-polymeric conductive film, and a plurality of insulating spacers. The first signal line is formed on the first transparent substrate, the first polymeric conductive film is formed on the first transparent substrate, and the first non-polymeric conductive film is formed on the first polymeric conductive film. The second signal line is provided on the second transparent substrate, the second non-polymeric conductive film is provided on the second transparent substrate, and the insulating spacers are provided between the first transparent substrate and the second transparent substrate.

In one embodiment, a second polymeric conductive film is further provided between the second transparent substrate and the second non-polymeric conductive film.

In one embodiment, the polymeric conductive film is made of a PEDOT/PSS conductive polymer, an unsaturated conjugate conductive polymer, a sulfur-containing conductive polymer, or an amine-containing conductive polymer.

In one embodiment, the polymeric conductive film is made of a conductive polymer composite, and the conductive polymer composite is a PEDOT/PSS conductive polymer doped with inorganic conductive material, an unsaturated conjugate conductive polymer doped with inorganic conductive material, a sulfur-containing conductive polymer doped with inorganic conductive material, or an amine-containing conductive polymer doped with inorganic conductive material.

In one embodiment, the polymeric conductive film is made of a conductive polymer composite, and the conductive polymer composite is made of a PEDOT/PSS conductive polymer doped with a carbon compound, an unsaturated conjugate conductive polymer doped with a carbon compound, a sulfur-containing conductive polymer doped with a carbon compound, or an amine-containing conductive polymer doped with a carbon compound.

In one embodiment, the non-polymeric conductive film is made of a metallic oxide material such as ITO, IZO, GZO, AZO, or ZnO.

According to the above embodiments, a transparent conductive composite that includes both a polymeric conductive film and a non-polymeric conductive film serves as a conductive layer for the touch screen of a touch panel. Hence, on one hand, the non-polymeric conductive film allows to improve electrical conductivity and reduce surface resistivity, with these characteristics being inherently inferior in a polymeric conductive film, to avoid a drift to the linear response when one draws a line on the touch screen of a touch panel. On the other hand, even the non-polymeric conductive film splits or cracks through repetitive drawing, the polymeric conductive film that has competent flexibility allows to maintain electrical conduction and thus increase the bearable number of times for drawing a line on a touch screen.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a conventional touch panel.

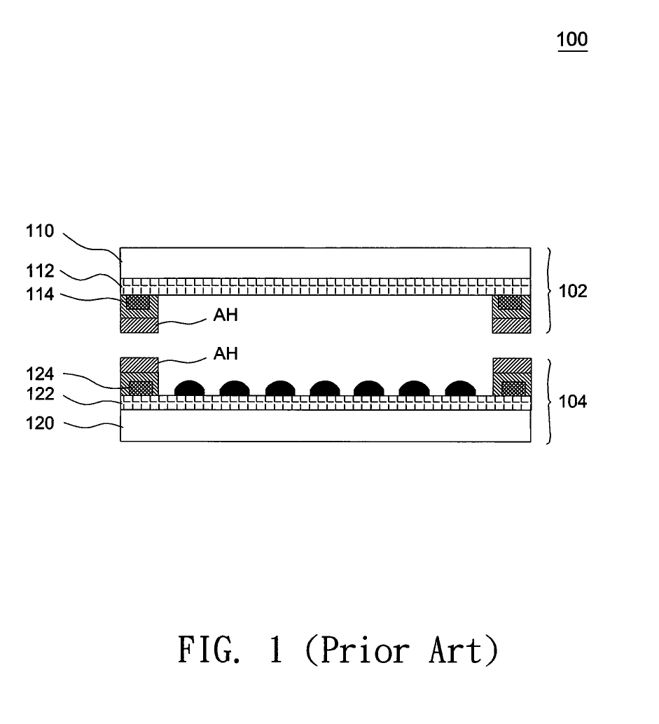

FIG. 2 shows a schematic diagram of another conventional touch panel.

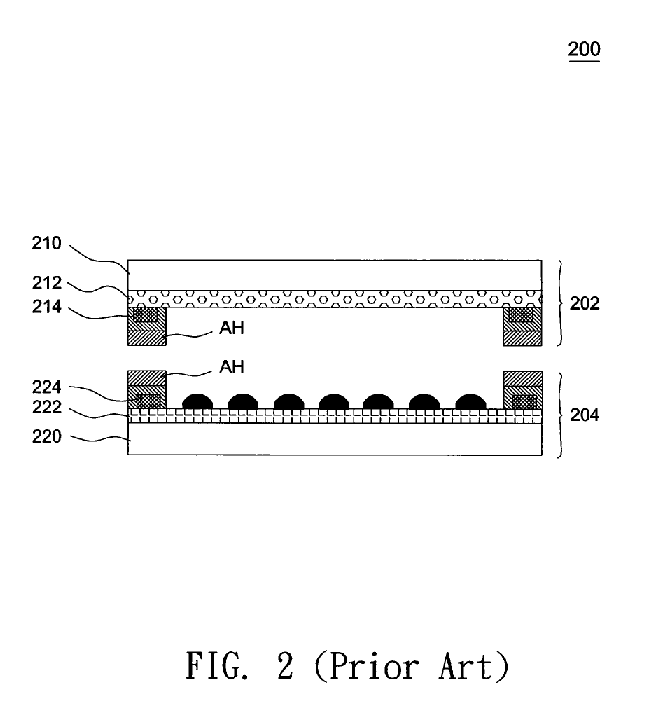

FIG. 3 shows a schematic diagram of a touch panel according to an embodiment of the invention.

FIG. 4 shows a schematic diagram of a touch panel according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections, couplings, and mountings. Similarly, “adjacent to” and variations thereof herein are used broadly and encompass directly and indirectly “adjacent to”. Therefore, the description of “A” component “adjacent to” “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

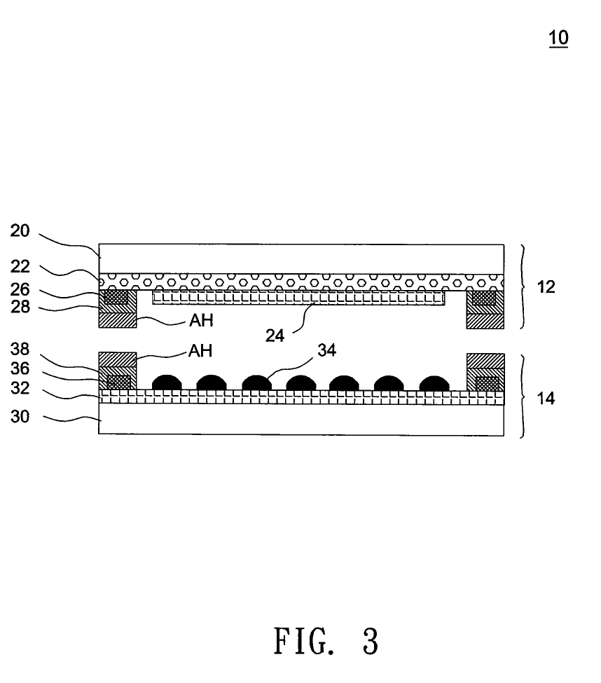

FIG. 3 shows a schematic diagram of a touch panel 10 according to an embodiment of the invention. Referring to FIG. 3, the touch panel 10 includes a top electrode substrate 12 and a bottom electrode substrate 14. The top electrode substrate 12 includes a transparent substrate 20, a polymeric conductive film 22 formed on the transparent substrate 20, and a non-polymeric conductive film 24 formed on the polymeric conductive film 22. The non-polymeric conductive film 24 substantially overlaps a touch screen of the touch panel 10. At least one signal transmission line 26 is formed on the periphery of the polymeric conductive film 22 and is insulated by an insulating layer 28.

The bottom electrode substrate 14 includes a transparent substrate 30, a non-polymeric conductive film 32 formed on the transparent substrate 30, and at least one signal transmission line 36. The signal transmission line 36 is formed on the periphery of the non-polymeric conductive film 32 and is insulated by an insulating layer 38. The top electrode substrate 12 and the bottom electrode substrate 14 are connected with each other through an adhesive AH, and multiple insulating spacers 34 are provided on the non-polymeric conductive film 32 to maintain a gap between the top electrode substrate 12 and the bottom electrode substrate 14. The transparent substrates 20 and 30 may be made of polycarbonate (PC) plastic, polystyrene (PS) plastic, polyethylene terephthalate (PET) plastic, glass, or a polymer/inorganics composite such as a composite formed by adding SiO₂ into polycarbonate plastic or polyethylene terephthalate plastic. In one embodiment, the polymeric conductive film 22 is made of a PEDOT/PSS conductive polymer, an unsaturated conjugate conductive polymer, a sulfur-containing conductive polymer, or an amine-containing conductive polymer. In an alternate embodiment, the polymeric conductive film 22 is made of a conductive polymer composite, and the conductive polymer composite may be a PEDOT/PSS conductive polymer doped with inorganic conductive material (such as a conductive metal), an unsaturated conjugate conductive polymer doped with inorganic conductive material, a sulfur-containing conductive polymer doped with inorganic conductive material, or an amine-containing conductive polymer doped with inorganic conductive material. In an alternate embodiment, the polymeric conductive film 22 is made of another conductive polymer composite, and the conductive polymer composite may be made of a PEDOT/PSS conductive polymer doped with a carbon compound, an unsaturated conjugate conductive polymer doped with a carbon compound, a sulfur-containing conductive polymer doped with a carbon compound, or an amine-containing conductive polymer doped with a carbon compound. The carbon compound may be made from a carbon nanotube, a carbon fiber, or a bamboo charcoal. Further, in one embodiment, the non-polymeric conductive film 32 is made of metallic oxide such as ITO, IZO, GZO, AZO, or ZnO. Further, the metallic oxide may be sputtered on the polymeric conductive film 22, and the adhesive AH may be a pressure sensitive adhesive.

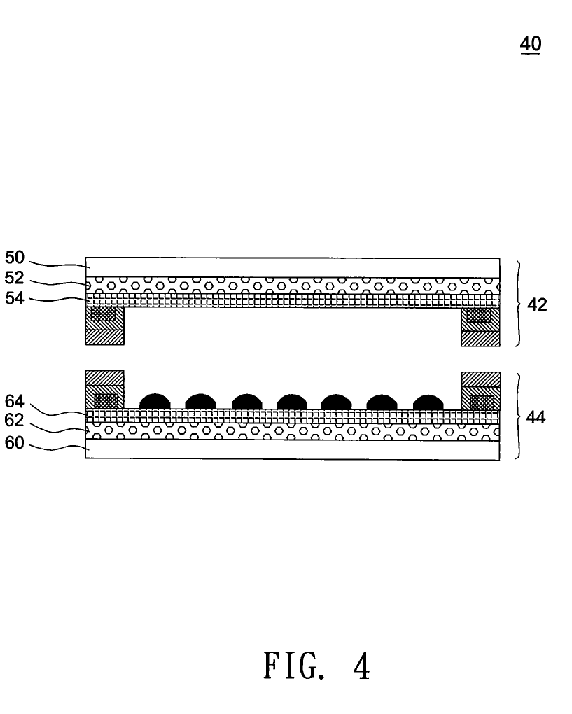

FIG. 4 shows a schematic diagram of a touch panel 40 according to another embodiment of the invention. This embodiment is similar to the embodiment shown in FIG. 3, except each of a top electrode substrate 42 and a bottom electrode substrate 44 have a polymeric conductive film and a non-polymeric conductive film. Referring to FIG. 4, in the top electrode substrate 42, a polymeric conductive film 52 is formed on one surface of a transparent substrate 50 facing the bottom electrode substrate 44, and a non-polymeric conductive film is formed on an entire surface of the polymeric conductive film 52. In the bottom electrode substrate 44, a polymeric conductive film 62 is formed on the transparent substrate 60, and a non-polymeric conductive film 64 is formed on an entire surface of the polymeric conductive film 62.

According to the above embodiments, a transparent conductive composite that includes both a polymeric conductive film and a non-polymeric conductive film serves as a conductive layer for the touch screen of a touch panel. Hence, on one hand, the non-polymeric conductive film allows to improve electrical conductivity and reduce surface resistivity, with these characteristics being inherently inferior in a polymeric conductive film, to avoid a drift to the linear response when one draws a line on the touch screen of a touch panel. On the other hand, even the non-polymeric conductive film splits or cracks through repetitive drawing, the polymeric conductive film that has competent flexibility allows to maintain electrical conduction and thus increase the bearable number of times for drawing a line on a touch screen. According to the result of an experiment performed by the inventor, the touch panel in each of the above embodiments may endure 100,000 times of line drawing and not crack or bend even 130,000 times of line drawing is performed. Further, the natural light blue color of the polymeric conductive film may compensate the light yellow screen color of a touch panel to provide fine color tone.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch panel, comprising:
a first transparent substrate and a second transparent substrate facing to each other;
a first signal line formed on the first transparent substrate;
a first polymeric conductive film formed on the first transparent substrate;
a first non-polymeric conductive film formed on the first polymeric conductive film;
a second signal line provided on the second transparent substrate;
a second non-polymeric conductive film provided on the second transparent substrate; and
a plurality of insulating spacers provided between the first transparent substrate and the second transparent substrate.

2. The touch panel as claimed in claim 1, further comprising:
a second polymeric conductive film provided between the second transparent substrate and the second non-polymeric conductive film.

3. The touch panel as claimed in claim 1, wherein the polymeric conductive film is made of a PEDOT/PSS conductive polymer, an unsaturated conjugate conductive polymer, a sulfur-containing conductive polymer, or an amine-containing conductive polymer.

4. The touch panel as claimed in claim 1, wherein the polymeric conductive film is made of a conductive polymer composite, and the conductive polymer composite is a PEDOT/PSS conductive polymer doped with inorganic conductive material, an unsaturated conjugate conductive polymer doped with inorganic conductive material, a sulfur-containing conductive polymer doped with inorganic conductive material, or an amine-containing conductive polymer doped with inorganic conductive material.

5. The touch panel as claimed in claim 4, wherein the inorganic conductive material is a conductive metal.

6. The touch panel as claimed in claim 1, wherein the polymeric conductive film is made of a conductive polymer composite, and the conductive polymer composite is made of a PEDOT/PSS conductive polymer doped with a carbon compound, an unsaturated conjugate conductive polymer doped with a carbon compound, a sulfur-containing conductive polymer doped with a carbon compound, or an amine-containing conductive polymer doped with a carbon compound.

7. The touch panel as claimed in claim 6, wherein the carbon compound is made from a carbon nanotube, a carbon fiber, or a bamboo charcoal.

8. The touch panel as claimed in claim 1, wherein the non-polymeric conductive film is made of a metallic oxide material.

9. The touch panel as claimed in claim 8, wherein the metallic oxide material is ITO, IZO, GZO, AZO, or ZnO.

10. The touch panel as claimed in claim 1, further comprising:
a first insulating layer for insulating the first signal line;
a second insulating layer for insulating the second signal line; and
an adhesive provided between the first insulating layer and the second insulating layer.

11. The touch panel as claimed in claim 1, wherein the adhesive is a pressure sensitive adhesive.

12. The touch panel as claimed in claim 1, wherein the first and the second transparent substrates are made of polyethylene terephthalate.

13. A touch panel comprising a first electrode substrate and a second electrode substrate that face to each other and are connected with each other by an adhesive with a gap formed therebetween, wherein at least one of the first and the second electrode substrates has a transparent conductive composite and the transparent conductive composite comprises a polymeric conductive film and a non-polymeric conductive film that are in contact with each other.

14. The touch panel as claimed in claim 13, wherein the polymeric conductive film is made of a PEDOT/PSS conductive polymer, an unsaturated conjugate conductive polymer, a sulfur-containing conductive polymer, or an amine-containing conductive polymer.

15. The touch panel as claimed in claim 13, wherein the polymeric conductive film is made of a conductive polymer composite, and the conductive polymer composite is a PEDOT/PSS conductive polymer doped with inorganic conductive material, an unsaturated conjugate conductive polymer doped with inorganic conductive material, a sulfur-containing conductive polymer doped with inorganic conductive material, or an amine-containing conductive polymer doped with inorganic conductive material.

16. The touch panel as claimed in claim 15, wherein the inorganic conductive material is a conductive metal.

17. The touch panel as claimed in claim 13, wherein the polymeric conductive film is made of a conductive polymer composite, and the conductive polymer composite is made of a PEDOT/PSS conductive polymer doped with a carbon compound, an unsaturated conjugate conductive polymer doped with a carbon compound, a sulfur-containing conductive polymer doped with a carbon compound, or an amine-containing conductive polymer doped with a carbon compound.

18. The touch panel as claimed in claim 17, wherein the carbon compound is made from a carbon nanotube, a carbon fiber, or a bamboo charcoal.

19. The touch panel as claimed in claim 13, wherein the non-polymeric conductive film is made of a metallic oxide material.

20. The touch panel as claimed in claim 19, wherein the metallic oxide material is ITO, IZO, GZO, AZO, or ZnO.
